(19) United States
(12) Patent Application Publication
(10) Pub. No.: US 2009/0247217 A1
(43) Pub. Date: Oct. 1, 2009

(54) APPARATUS AND METHOD FOR WIRELESS COMMUNICATIONS CAPABLE OF BLUETOOTH, WIRELESS LOCAL AREA NETWORK (WLAN) AND WIMAX COMMUNICATIONS

(75) Inventors: Hong-Kai Hsu, Taipei County (TW); Chung-Shine Huang, Taipei Hsien (TW); Wei-Lun Wan, Hsinchu City (TW); Ying-Chi Kuo, Tainan City (TW); Jiun-Jang Su, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/056,335

(22) Filed: Mar. 27, 2008

(51) Int. Cl. H04B 1/38; H04Q 7/24; H04B 7/00

(52) U.S. Cl. 455/553.1; 370/338; 455/41.2

(57) ABSTRACT

The invention provides an apparatus capable of wireless communications. In one embodiment, the apparatus comprises a packet traffic arbitration (PTA) module and a first wireless transceiving module, and the first wireless transceiving module is connected to the PTA module via a wire. The first wireless transceiving module sends a first request for performing a first signal transceiving to the PTA module via the wire, receives a first response to the first request via the wire, and performs the first signal transceiving when the first response indicates that the first request has been granted by the PTA module.

### BACKGROUND OF THE INVENTION

1. Field of the Invention

The invention relates to coordination between Bluetooth, Wireless Local Area Network (WLAN) and WiMAX communications, and more particularly to apparatus and method for wireless communications utilizing Bluetooth, WLAN and WiMAX.

2. Description of the Related Art

Bluetooth and WLAN are both important communication channels for commercial electronic products, such as mobile phones. Bluetooth and WLAN channels, however, both communicate via 2.4 GHz Industrial, Science, and Medical (ISM) band. Referring to FIG. 1A, a schematic diagram of a WLAN band conforming to the IEEE 802.11b standard is shown. Three static non-overlapping WLAN channels with bandwidths of 22 MHz are spread on a frequency band ranging from 2400 Hz to 2483.5 Hz. Referring to FIG. 1B, a schematic diagram of a Bluetooth band is shown. 79 Bluetooth hopping channels with bandwidths of 1 MHz are spread on a frequency band ranging from 2400 Hz to 2483.5 Hz. Moreover, modern 802.16a (WiMAX) channels are spread on a frequency band from the 2 to 11 GHz. If a commercial electronic device utilizes both a Bluetooth channel and a WLAN/WiMAX channel for communications, signal transceiving errors may be induced due to signal interference between simultaneously transmitted Bluetooth signals and WLAN/WiMAX signals, as the WLAN/WiMAX channel frequency band may overlap the Bluetooth channel frequency band. Thus, the invention provides a new apparatus and method utilizing both Bluetooth and WLAN/WiMAX communications which solve the above problem.

### BRIEF SUMMARY OF THE INVENTION

The invention provides an apparatus capable of wireless communications. In one embodiment, the apparatus comprises a packet traffic arbitration (PTA) module, and a first wireless transceiving module, and the first wireless transceiving module is coupled to the PTA module via a wire. The first wireless transceiving module sends a first request for performing a first signal transceiving to the PTA module via the wire, receives a first response to the first request via the wire, and performs the first signal transceiving when the first response indicates that the first request has been granted by the PTA module.

The invention also provides a method for operating an apparatus capable of Bluetooth and Wireless Local Area Network (WLAN)/WiMAX communications. In one embodiment, the apparatus comprises a Bluetooth module for Bluetooth communications and a WLAN/WiMAX module for WLAN/WiMAX communications, and a packet traffic arbitration (PTA) module. First, a first request is generated and sent from the Bluetooth module to the PTA module via a wire connected therebetween, when the Bluetooth module is required to perform Bluetooth signal transceiving. A first response indicating whether the WLAN chip has granted the first request is then generated with the WLAN chip and then sent from the PTA module to the Bluetooth module via the wire. When the Bluetooth module receives the first response indicating the first request is granted, the Bluetooth module performs Bluetooth signal transceiving. When the Bluetooth module receives the first response indicating the first request is rejected, then the Bluetooth module suppresses Bluetooth signal transceiving.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic diagram of a WLAN band conforming to the IEEE 802.11b standard;

FIG. 1B is a schematic diagram of a Bluetooth band;

FIG. 2 is a block diagram of an embodiment of an apparatus capable of Bluetooth and WLAN communications according to the invention;

FIG. 3 is a block diagram of another embodiment of an apparatus capable of Bluetooth and WLAN communications according to the invention;

FIG. 4A is a timing diagram of Bluetooth signal transceiving request and response transmitted on one wire according to the invention;

FIG. 4B is a schematic diagram of four exemplary categories of Bluetooth packets with different transceiving time period lengths according to the invention;

FIGS. 5A and 5B show embodiments for transceiving medium Bluetooth packets according to the invention;

FIGS. 6A and 6B show embodiments for transceiving short Bluetooth packets according to the invention; and

FIGS. 7A and 7B show embodiments for transceiving multi-slot Bluetooth packets according to the invention.

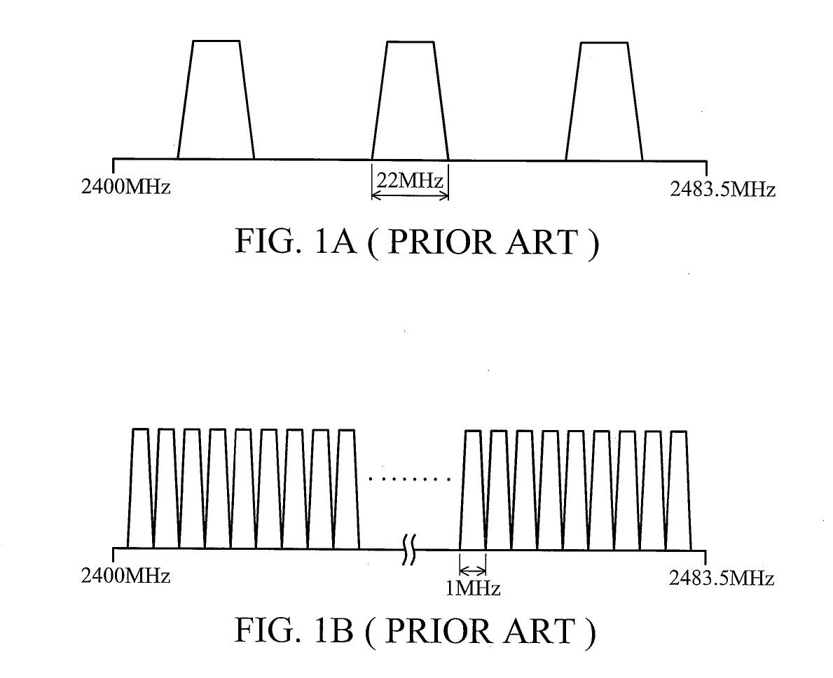

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

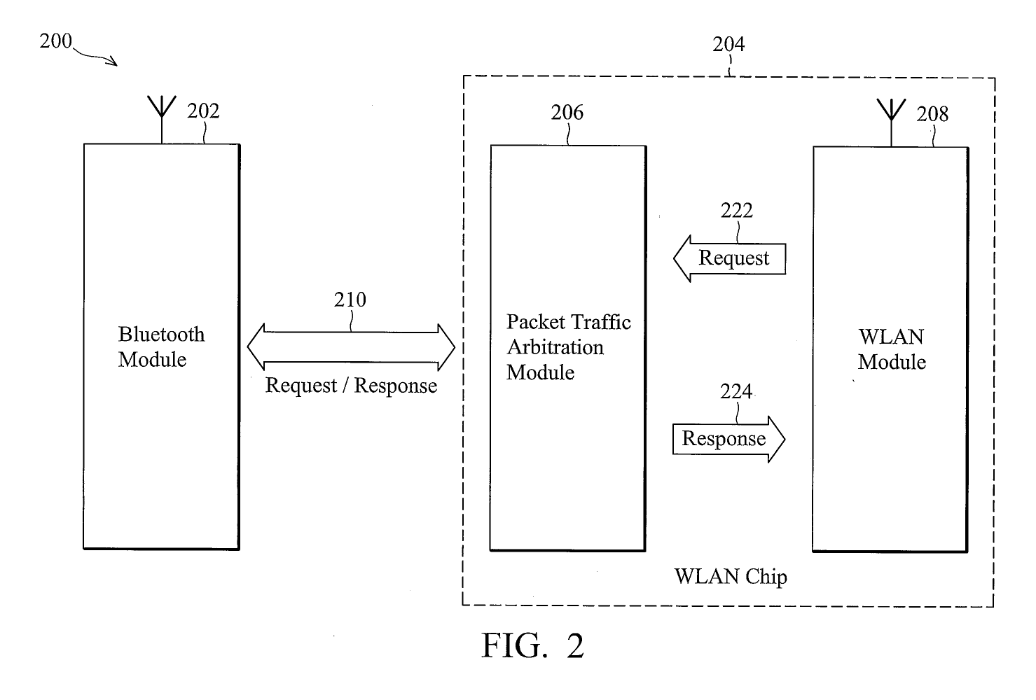

Referring to FIG. 2, a block diagram of an embodiment of an apparatus 200 capable of Bluetooth and WLAN communications according to the invention is shown. The apparatus 200 comprises a Bluetooth Module 202 for Bluetooth communications, and a WLAN chip 204 for WLAN communications. The WLAN chip 204 comprises two sub-modules, a WLAN module 208 for WLAN communications and a packet traffic arbitration (PTA) module 206. To avoid signal interference between a Bluetooth signal sent by the Bluetooth module 202 and a WLAN signal sent by the WLAN module 208, the Bluetooth module 202 must be coupled to the WLAN chip 204 for negotiating signal transceiving to avoid signal collision. To reduce hardware costs and power consumption, a wire 210 is connected between the Bluetooth module and the WLAN chip. Note that, the apparatus 200 may be devised to provide capability of Bluetooth and WiMAX communications, and the WLAN chip 204 may be replaced with a WiMAX chip comprising a WiMAX module and the PTA module 206. Or, the apparatus 200 may be devised to provide capability of WLAN and WiMAX communications, and the Bluetooth module 302 may be replaced with a WiMAX module. The interoperations between the Bluetooth and WiMAX modules, and WLAN and WiMAX modules through the PTA arbitration module 206 may be deduced by the analogy and is briefly described herein for brevity. It is to be understood that the Bluetooth Module, WLAN and WiMAX modules may also be called wireless transceiving modules.

The PTA module 206 is an arbiter determining which of the WLAN module 208 and the Bluetooth module 202 is granted to perform signal transceiving at specific time periods. When the Bluetooth module 202 is required to perform Bluetooth signal transceiving, the Bluetooth module 202 sends a request to the PTA module 206 via the wire 210. If the WLAN module 208 is not transmitting a WLAN signal or receiving a WLAN signal, the PTA module 206 grants the request sent by the Bluetooth module 202. Otherwise, if the WLAN module 208 is transmitting a WLAN signal or receiving a WLAN signal, the PTA module 206 rejects the request sent by the Bluetooth module 202.

The PTA module 206 then sends a response to the Bluetooth module 202 in reply to the previous request via the wire 210, wherein the response indicates whether the request is been granted by the PTA module 206. The Bluetooth module 202 inspects the voltage of the wire 210 to determine whether the request has been granted. When the request has been granted, the Bluetooth module 202 performs Bluetooth signal transceiving. When the request has been rejected, the Bluetooth module 202 suppresses Bluetooth signal transceiving, and sends another request for performing Bluetooth signal transceiving in a next Bluetooth slot.

When the WLAN module 208 is required to perform WLAN signal transceiving, the WLAN module 208 sends a request 222 to the PTA module 206. If the Bluetooth module 202 is not transmitting a Bluetooth signal or receiving a Bluetooth signal, the PTA module 206 grants the request 222 sent by the WLAN module 208. Otherwise, if the Bluetooth module 202 is transmitting a Bluetooth signal or receiving a Bluetooth signal, the PTA module 206 rejects the request sent by the WLAN module 208.

The PTA module 206 then sends a response 224 to the WLAN module 208 in reply to the request 222, wherein the response 224 indicates whether the request 222 has been granted by the PTA module 306. When the response 224 indicates that the request 222 has been granted, the WLAN module 208 performs WLAN signal transceiving. When the request 222 is rejected, the WLAN module 208 suppresses WLAN signal transceiving.

When both the Bluetooth module 202 and the WLAN module 208 simultaneously sends requests for signal transceiving to the PTA module 206 in the same time slot, the PTA module 206 grants only one of the requests to avoid signal interference between Bluetooth and WLAN signal transceiving. Thus, only one of the Bluetooth module 202 and the WLAN module 208 can transmit or receive signals at a time and errors due to signal interference is therefore avoided.

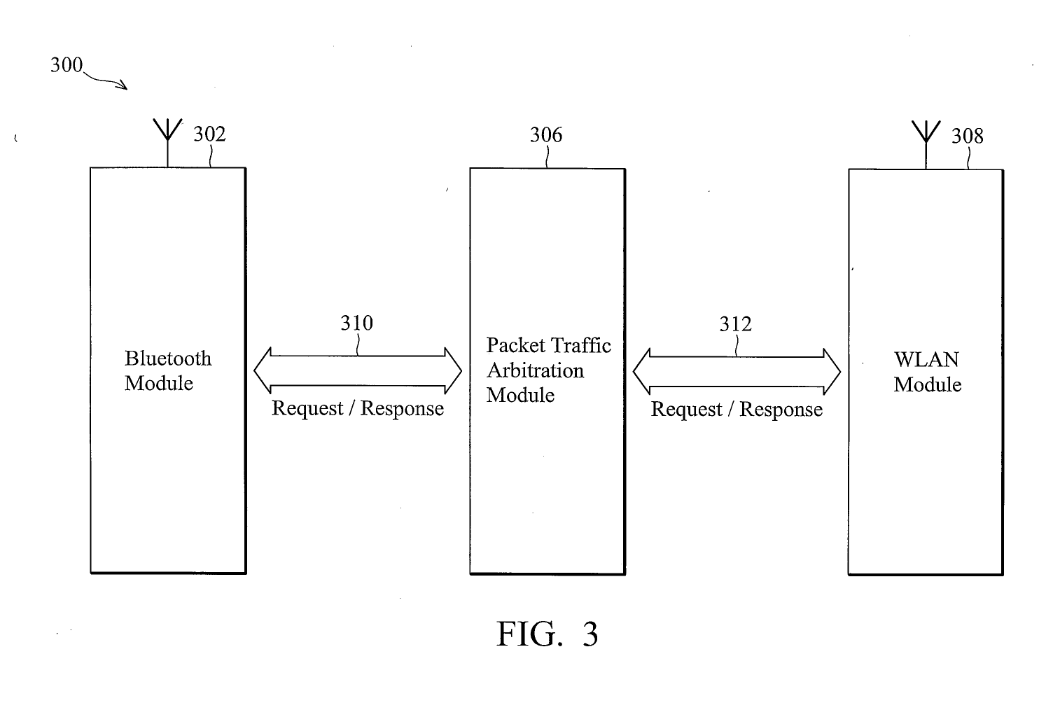

When a PTA module is not bound to a WLAN module in a WLAN chip, the WLAN module can also transmit requests to the PTA module and receive responses from the PTA module via a shared wire. Referring to FIG. 3, a block diagram of another embodiment of an apparatus 300 capable of Bluetooth and WLAN communications according to the invention is shown. The apparatus 300 comprises a Bluetooth module 302 for Bluetooth signal transceiving, a PTA module 306, and a WLAN module 308 for WLAN signal transceiving. The PTA module 306 arbitrates requests from the Bluetooth module 302 and the WLAN module 308 as the PTA module 206 of FIG. 2. The WLAN module 308 is coupled to the PTA module 306 via a wire 312 and requests and responses are transmitted via the wire 312. Thus, hardware costs and power consumption of the apparatus 300 is further reduced. Note that, the apparatus 300 may be devised to provide capability of Bluetooth/WLAN and WiMAX communications, and the Bluetooth module 302 or the WLAN module 308 may be replaced with a WiMAX module.

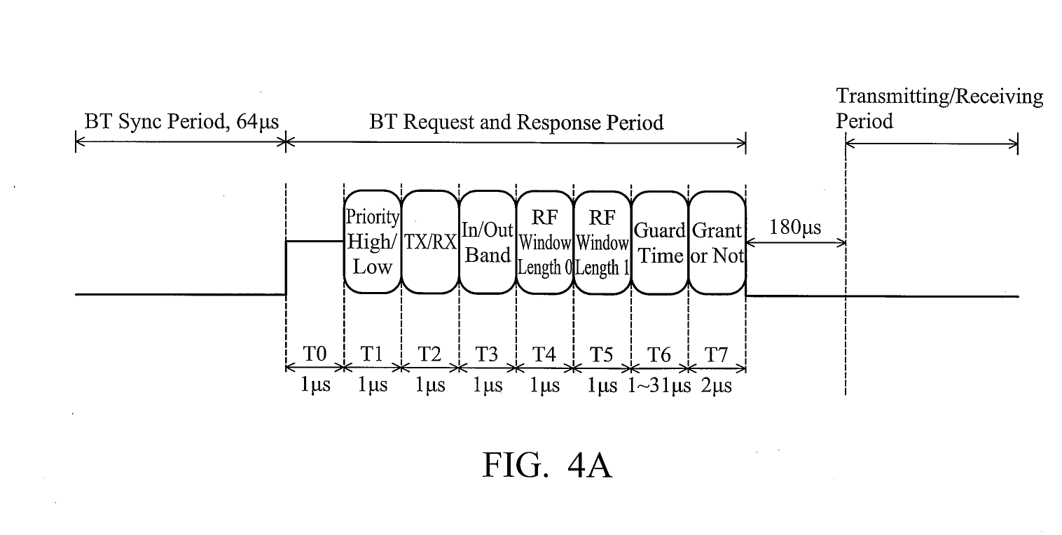

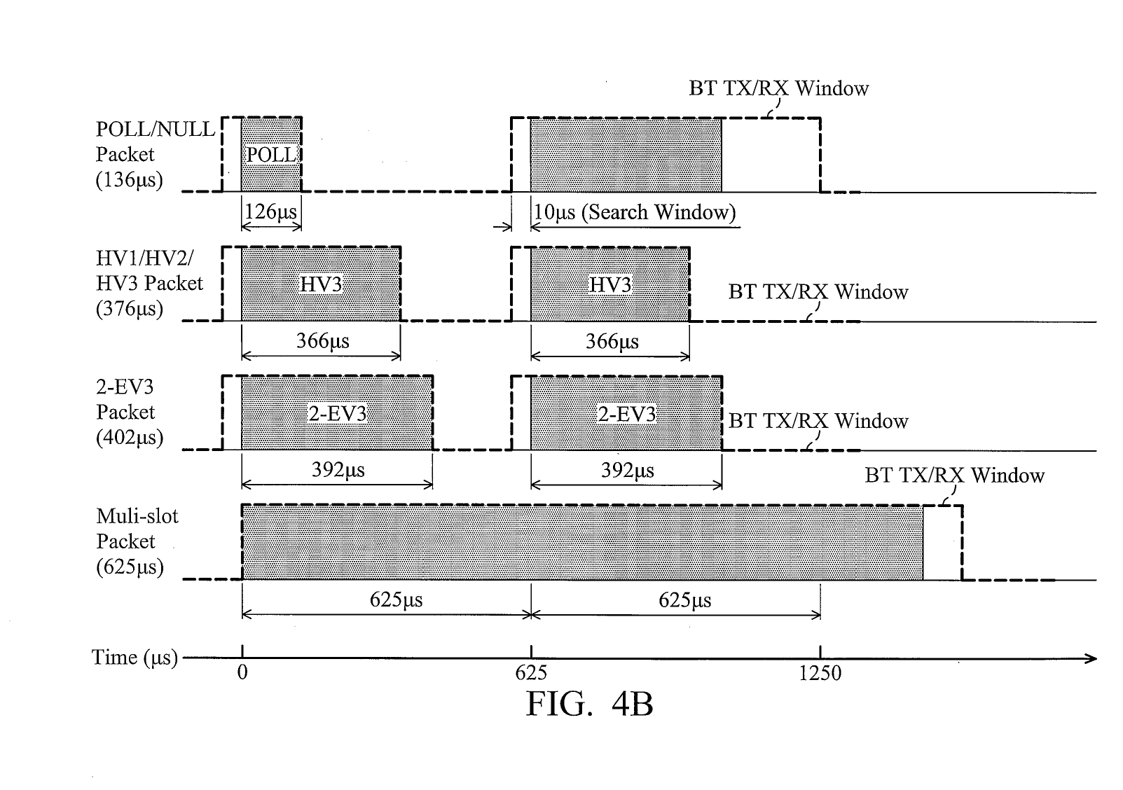

Referring to FIG. 4A, a timing diagram of Bluetooth signal transceiving request and response transmitted on one wire according to the invention is shown, shared to transmit requests and responses thereon. A Bluetooth signal is transmitted and received in a frame of 1250 μs in length. Each frame comprises two slots with a time period of 625 μs, and a frame generally comprises a slot for signal transmission and a slot for signal reception. When the Bluetooth module 202 is required to perform signal transceiving in a specific frame, the Bluetooth module 202 sends a request prior to an initial time of the specific frame. The Bluetooth module 202 raises the voltage of the wire 210 to a high level during a 1 μs period T0 to request signal transceiving to the PTA module 206. If the PTA module 206 receives the high voltage during the period T0, the PTA module 206 has received the Bluetooth module 202 request in the wire 210.

After the request is transmitted during the period T0, the Bluetooth module 202 then sends a series of status information bits via the wire 210 coupled between the Bluetooth module 202 and the PTA module 206. In subsequent 1 μs periods T1, T2, and T3, a priority bit, a TX/RX bit, and an In/Out band bit are respectively sent by the Bluetooth module 202. When the wire 210 has a high level during the period T1, the priority bit indicates that the priority of the Bluetooth request is high or low, and otherwise the priority bit indicates that the priority of the Bluetooth request is the opposite one. When the wire 210 has a high level during the period T2, the TX/RX bit indicates that the request is to transmit or receive a Bluetooth signal, and otherwise the TX/RX bit indicates that the request is to receive or transmit a Bluetooth signal. When the wire 210 has a high level during the period T3, the In/Out band bit indicates that a frequency range of the requested Bluetooth signal transceiving overlaps a frequency range of a WLAN signal transceiving. In one embodiment, subsequent two information bits transmitted in periods T4 and T5 describe a time period length of the requested Bluetooth signal transceiving.

After the information bits of the request have passed to the PTA module 206 via the wire 210, a guard interval T6 of 1˜31 μs is implemented. The PTA module 206 then determines whether to grant the request of the Bluetooth module 202 according to the received status information bits and information from a WLAN or WiMAX module. If the request has been granted, the PTA module 206 lowers the voltage of the wire 210 to a low level during a time period containing T6 of 1˜31 μs and T7 of 2 μs. If the request has been rejected, the PTA module 206 raises the voltage of the wire 210 to a high level during the time period containing T6 and T7. Or, those skilled in the art may realize that the PTA module 206 raises the voltage of the wire 210 to a high level during a time period containing T6 of 1˜31 μs and T7 of 2 μs when granting, and lowers the voltage of the wire 210 to a low level when rejecting. The Bluetooth module 202 can therefore measure (detect) the voltage of the wire 210 during the period T7 to determine whether the request has been granted by the PTA module 206. If the request has been granted, the Bluetooth module 202 can then start to perform Bluetooth signal transceiving after a 180 μs waiting period. Those skilled in the art may realize a WLAN or WiMAX signal transceiving request and response transmitted on one wire by the analogy.

Referring to FIG. 4B, a schematic diagram of four exemplary categories of Bluetooth packets with different transceiving time period lengths according to the invention is shown. Because the request shown in FIG. 4A comprises 2 length bits, the Bluetooth packets are classified into four categories respectively indicated by length bits “00”, “01”, “10”, and “11”. A first packet category has a transceiving time period of 126 μs and refers to a POLL packet or a NULL packet. A second packet category has a transceiving time period of 376 μs and refers to an HV1 packet, an HV2 packet, or an HV3 packet. For example, HV1 packet may carry 10 user payload bytes protected with 1/3 FEC (forward error correction). No CRC (cyclic redundancy check) is used. HV1 packet may be sent at every two slots and carry 1.25 ms of speech at a 64 kb/s rate. HV2 packet may carry 20 user payload bytes protected with a rate 2/3 FEC and be sent at every four slots. HV3 packet may carry 30 unprotected user payload bytes and be sent at every six slots. A third packet category has a transceiving time period of 402 μs and refers to a 2-EV3 packet. A fourth packet category has a transceiving time period of more than 625 μs and refers to a multi-slot packet. Thus, the Bluetooth module 202 can inform the PTA module 206 of a time period length of the requested Bluetooth signal transceiving with a request comprising 2 length bits.

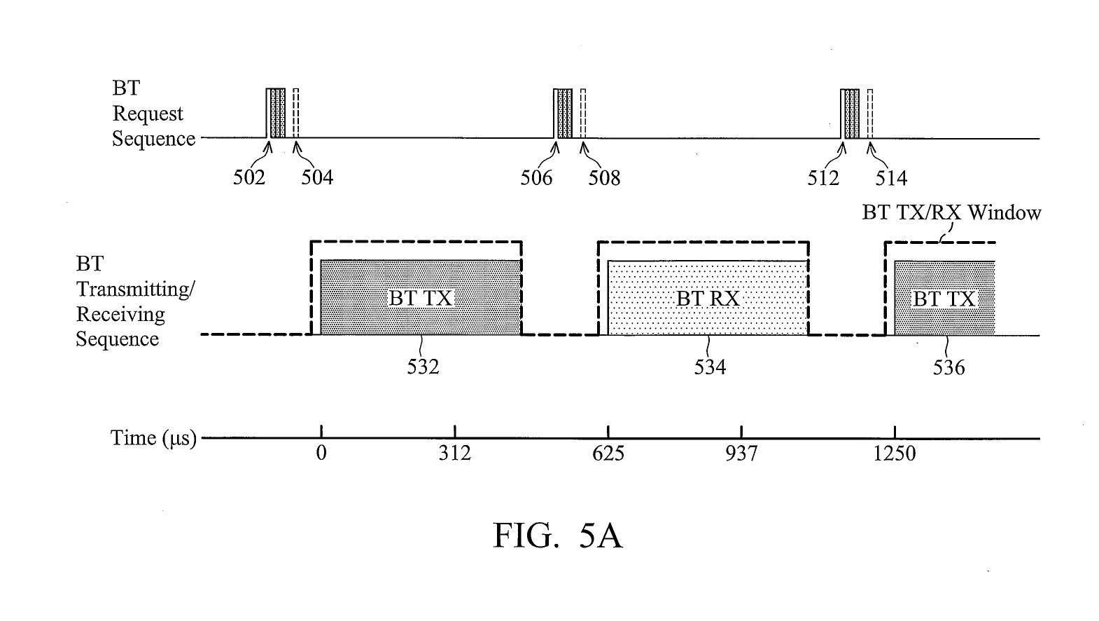

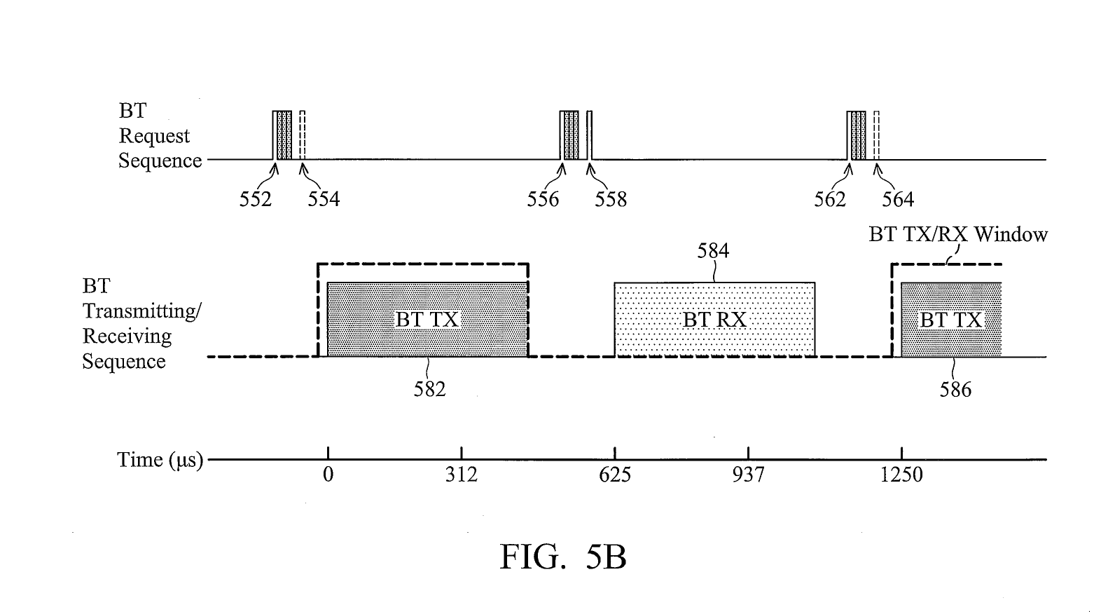

Referring to FIG. 5A, a first embodiment for transceiving one category of Bluetooth packets according to the invention is shown. Prior to a time at 0 μs, the Bluetooth module 202 first sends a request 502 to the PTA module 206 via the wire 210 (FIG. 2) or 310 (FIG. 3), and the PTA module 206 grants the request 502 with a response 504 via the wire 210 or 310. At time 0 μs, the Bluetooth module 202 then by wireless transmission, transmits a Bluetooth medium packet 532 which has a time period shorter than a Bluetooth slot of 625 μs. Prior to a time at 625 μs, the Bluetooth module 202 then sends a request 506 to the PTA module 206 via the wire 210 or 310, and the PTA module 206 grants the request 506 with a response 508 via the wire 210 or 310. At time 625 μs, the Bluetooth module 202 then by wireless transmission receives a Bluetooth medium packet 534 which also has a time period shorter than 625 μs.

Referring to FIG. 5B, a second embodiment for transceiving medium Bluetooth packets according to the invention is shown. A first request 552 sent by the Bluetooth module 202 via the wire 210 (FIG. 2) or 310 (FIG. 3) is granted by the PTA module 206 with a response 554 via the wire 210 or 310, and the Bluetooth module 202 then transmits a Bluetooth medium packet 582 by wireless transmission. The Bluetooth module 202 then sends a request 556 to the PTA module 206 via the wire 210 or 310. The PTA module 206, however, rejects the request 556 with a response 558 via the wire 210 or 310. The Bluetooth module 202 therefore does not receive a Bluetooth medium packet 584.

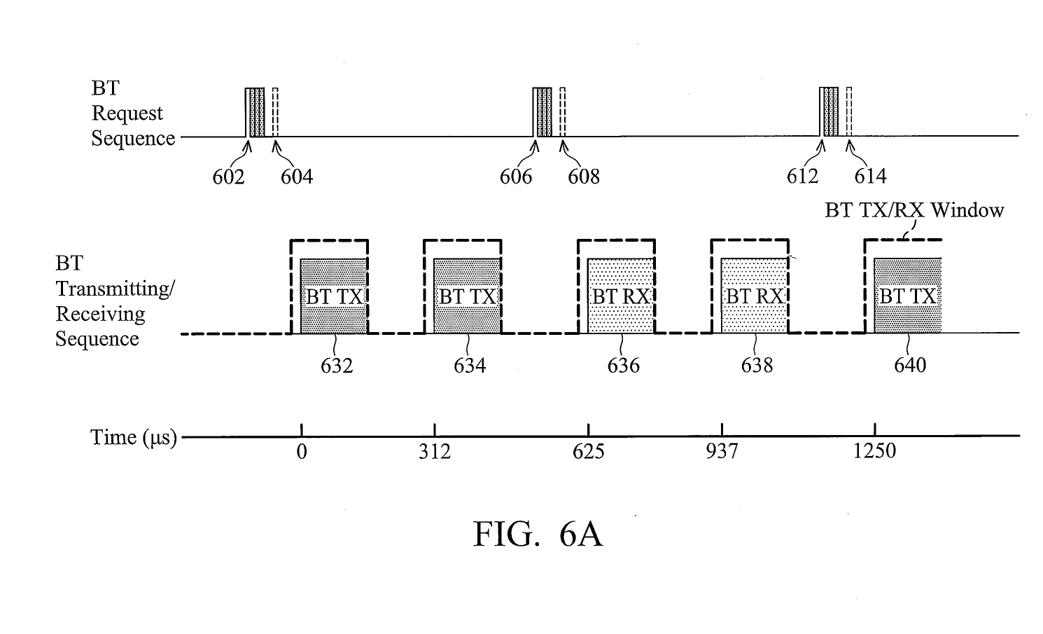

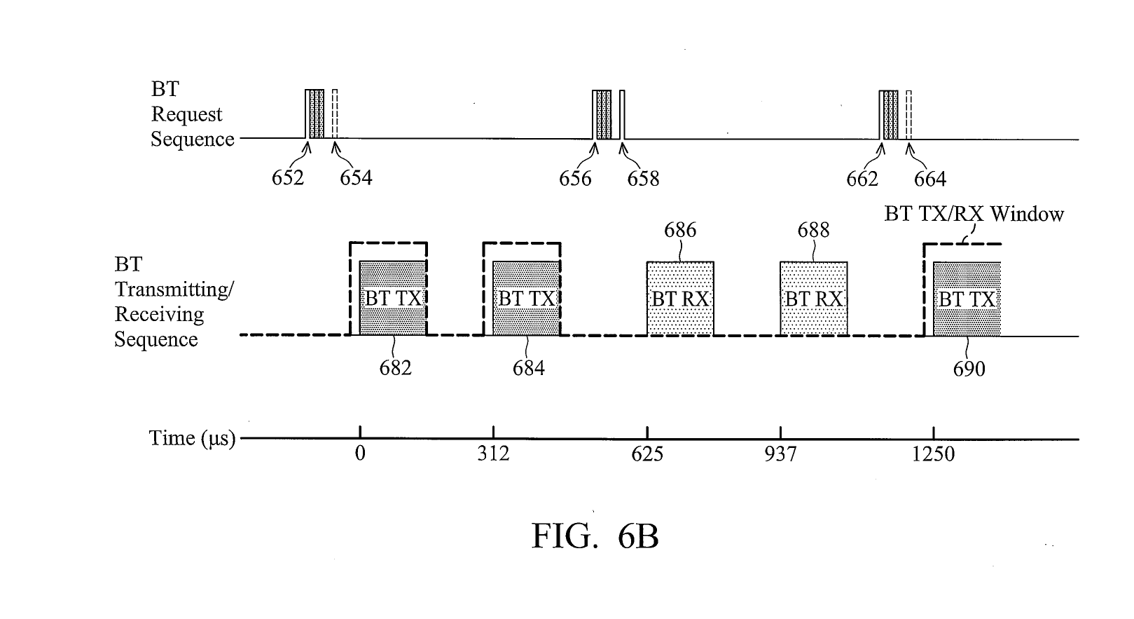

Referring to FIG. 6A, a first embodiment for transceiving short Bluetooth packets according to the invention is shown. Prior to a time at 0 μs, the Bluetooth module 202 first sends a request 602 to the PTA module 206 via the wire 210 (FIG. 2) or 310 (FIG. 3), and the PTA module 206 grants the request 602 with a response 604 via the wire 210 or 310. The Bluetooth module 202 then sequentially transmits two Bluetooth short packets 632 and 634 in a first slot from 0 μs to 625 μs. Prior to a time at 625 μs, the Bluetooth module 202 sends a second request 606 to the PTA module 206 via the wire 210 or 310, and the PTA module 206 grants the request 606 with a response 608 via the wire 210 or 310. At time 625 μs, the Bluetooth module 202 then sequentially receives two Bluetooth short packets 636 and 638 in a second slot from 625 μs to 1250 μs.

Referring to FIG. 6B, a second embodiment for transceiving short Bluetooth packets according to the invention is shown. A first request 652 sent by the Bluetooth module 202 via the wire 210 (FIG. 2) or 310 (FIG. 3) is granted by the PTA module 206 with a response 654 via the wire 210 or 310, and the Bluetooth module 202 then transmits two Bluetooth short packets 682 and 684 in a first slot from 0 μs to 625 μs. The Bluetooth module 202 then sends a second request 656 to the PTA module 206 via the wire 210 or 310. The PTA module 206, however, rejects the request 656 with a response 658 via the wire 210 or 310, and the Bluetooth module 202 therefore does not receive two Bluetooth short packets 686 and 688 in a second slot from 625 μs to 1250 μs.

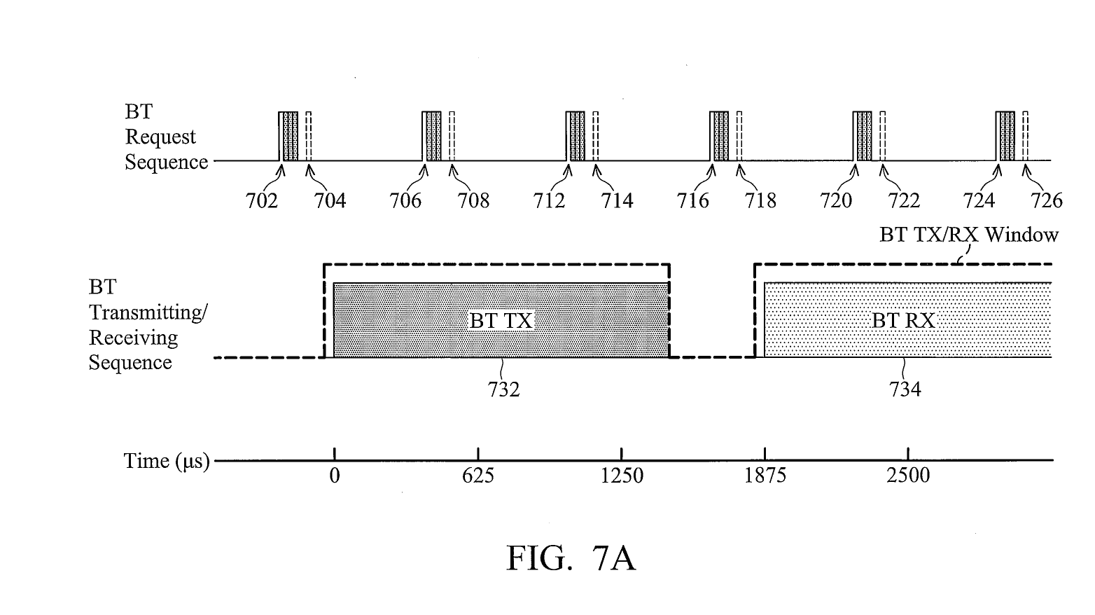

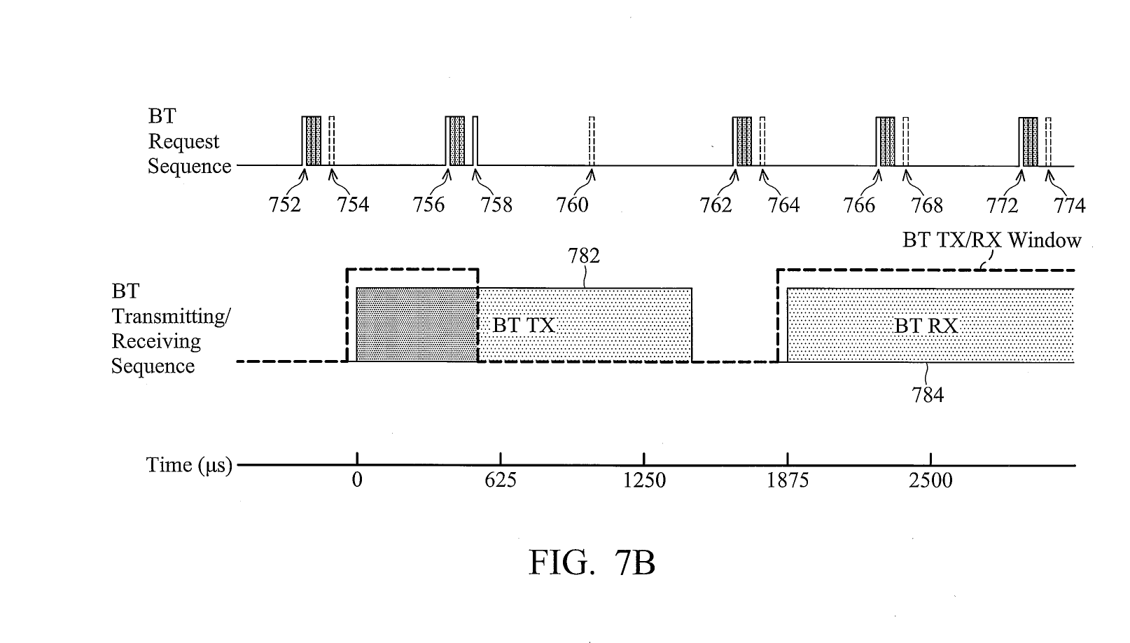

Referring to FIGS. 7A and 7B, embodiments for transceiving multi-slot Bluetooth packets according to the invention is shown. Because a multi-slot Bluetooth packet has a transmission period greater than 625 μs, transceiving of a multi-slot Bluetooth packet requires more than one Bluetooth slot. Because each request corresponds to a Bluetooth slot, the Bluetooth module 202 sends requests 702, 706, and 712 for transmitting the multi-slot packet 732 via the wire 210 (FIG. 2) or 310 (FIG. 3), and sends requests 716, 720, and 724 for receiving the multi-slot packet 734 via the wire 210 or 310. When the Bluetooth module 202 sends a request 756 for transmitting the multi-slot packet 782 in FIG. 7B, the PTA module 206 rejects the request 756 with a response 758, and the Bluetooth module 202 does not completely transmit the multi-slot packet 782 since the request 756 is rejected.

The invention provides an apparatus capable of dual mode communications. The apparatus comprises a Bluetooth module for Bluetooth communications and a WLAN/WiMAX module for WLAN/WiMAX communications. The Bluetooth module is connected to a PTA module through a wire. When the Bluetooth is required to perform Bluetooth signal transceiving, the Bluetooth module sends a request to the PTA module via the wire, and receives a response of the PTA module via the wire to determine whether the request has been granted by the WLAN chip. Because request and response transmissions share the same wire connected between the Bluetooth module and the PTA module, hardware cost and power consumption of the apparatus is therefore reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus capable of wireless communications, comprising:
a packet traffic arbitration (PTA) module; and
a first wireless transceiving module, connecting to the PTA module, sending a first request for performing a first signal transceiving to the PTA module via only one wire, receiving a first response to the first request via the wire, and performing the first signal transceiving when the first response indicates that the first request has been granted by the PTA module.

2. The apparatus as claimed in claim 1, wherein the PTA module is encapsulated in a chip, and the chip comprises:
a second wireless transceiving module, sending a second request for performing a second signal transceiving to the PTA module, receiving a second response generated by the PTA module in response to the second request, and performing the second signal transceiving when the second response indicates that the second request has been granted by the PTA module.

3. The apparatus as claimed in claim 2, wherein the first wireless transceiving module is a Bluetooth module, and the second wireless transceiving module is a wireless local area network (WLAN) module.

4. The apparatus as claimed in claim 2, wherein when the Bluetooth module requests a time period for Bluetooth signal transceiving by the first request overlaps a time period for WLAN signal transceiving requested by the second request, the PTA module grants only one of the first request and the second request.

5. The apparatus as claimed in claim 1, wherein the first request sent by the Bluetooth module to the PTA module comprises status information corresponding to the signal transceiving to be performed.

6. The apparatus as claimed in claim 5, wherein the WLAN chip determines whether to grant the first request according to the status information.

7. The apparatus as claimed in claim 5, wherein the status information comprises a series of information bits transmitted through the wire.

8. The apparatus as claimed in claim 7, wherein the information bits comprises a priority bit indicating whether the priority of the first request is high or low, and a TX/RX bit indicating whether the first request for the first signal transceiving is to transmit wireless signal or to receive wireless signal.

9. The apparatus as claimed in claim 7, wherein the information bits comprises an In/Out band bit indicating whether a frequency range of a signal transmitted by the first wireless transceiving module overlaps a frequency range of a signal transmitted by a second wireless transceiving module.

10. The apparatus as claimed in claim 1, wherein the first request and the first response are sent prior to a specific slot reserved for a wireless signal transceiving, and if the first request has been granted, the wireless signal transceiving is performed in the specific slot.

11. The apparatus as claimed in claim 1, wherein the first wireless transceiving module is a Bluetooth module.

12. The apparatus as claimed in claim 1, wherein the first wireless transceiving module is a wireless local area network (WLAN) module.

13. The apparatus as claimed in claim 1, wherein the first wireless transceiving module is a WiMAX module.

14. A method for operating an apparatus capable of Bluetooth and Wireless Local Area Network (WLAN)/WiMAX communications, wherein the apparatus comprises a Bluetooth module for Bluetooth communications, a WLAN/WiMAX module for WLAN/WiMAX communications, and a packet traffic arbitration (PTA) module, and the method comprising:
generating and sending a first request from the Bluetooth module to the PTA module via only one wire connected therebetween when the Bluetooth module is required to perform Bluetooth signal transceiving;
generating and sending a first response from the PTA module to the Bluetooth module via the wire, indicating whether the PTA module has granted the first request;
when the Bluetooth module receives the first response indicating the first request has been granted, performing Bluetooth signal transceiving with the Bluetooth module; and
when the Bluetooth module receives the first response indicating the first request has been rejected, suppressing Bluetooth signal transceiving.

15. The method as claimed in claim 14, further comprising:
generating and sending a second request from the WLAN/WiMAX module to the PTA module when the WLAN/WiMAX module is required to perform WLAN/WiMAX signal transceiving;
generating and sending a second response in reply to the second request with the PTA module to indicate whether the PTA module has granted the second request;
when the WLAN module receives the second response indicating that the second request has been granted, performing WLAN/WiMAX signal transceiving with the WLAN/WiMAX module; and
when the WLAN module receives that the second response indicating that the second request has been rejected, suppressing the WLAN/WiMAX signal transceiving.

16. The method as claimed in claim 15, wherein when a time period requested by the first request for Bluetooth signal transceiving overlaps a time period requested by the second request for WLAN/WiMAX signal transceiving, only one of the first request and the second request is granted by the PTA module.

17. The method as claimed in claim 15, wherein the first request further comprises status information corresponding to the Bluetooth signal transceiving to be performed.

18. The method as claimed in claim 17, wherein the PTA module determines whether to grant the first request according to the status information.

19. The method as claimed in claim 17, wherein the status information comprises a series of information bits sequentially transmitted through the wire.

20. The method as claimed in claim 19, wherein the information bits comprises a priority bit indicating whether the priority of the first request is high or low, and a TX/RX bit indicating whether the first request for Bluetooth signal transceiving is to transmit a Bluetooth signal or to receive a Bluetooth signal.

21. The method as claimed in claim 19, wherein the information bits comprises an In/Out band bit indicating whether a frequency range of a Bluetooth signal transmitted by the Bluetooth module overlaps a frequency range of a WLAN signal transmitted by the WLAN module.

22. The method as claimed in claim 14, wherein the first request is sent prior to a specific Bluetooth slot reserved for a Bluetooth signal transceiving, and the Bluetooth signal transceiving is performed in the specific Bluetooth slot if the first request has been granted.
